(19) United States
(12) Patent Application Publication
(10) Pub. No.: US 2019/0101434 A1
(43) Pub. Date: Apr. 4, 2019

(54) System and Method for Automatically Determining the Weight of Foods

(71) Applicant: Vorwerk & Co. Interholding GmbH, Wuppertal (DE)

(72) Inventor: Hendrik Koetz, Wetter (DE)

(21) Appl. No.: 16/095,062

(22) PCT Filed: Apr. 20, 2016
(86) PCT No.: PCT/EP2016/058814

§ 371 Date: Oct. 19, 2018

(51) Int. Cl. G01G 23/16; G01G 19/56

(52) U.S. Cl. CPC G01G 23/166; G01G 19/56

(57) ABSTRACT

The present invention relates to a system (1a; 1b; 1c; 1d; 1e) for preparing foods (100), comprising a housing (10) for receiving the food (100), a recognition device (20) for recognizing at least one food carrier (200) couplable with the system (1a; 1b; 1c; 1d; 1e), and thereby recognizing the weight of the food carrier (200), as well as a determining device (40) for determining the tare weight of the food based on the detected weight of the food carrier (200).

The present invention relates to a system, in particular an oven, as well as to a method for automatically determining the weight of food.

Systems and methods for determining the weight of food are known from the prior art, for example in the form of kitchen scales. The food can be placed directly on the kitchen scale, in order to determine the weight of food. Subsequently, the weight of the food can be read off a display device in a simple manner. This functions particularly simply, in particular in the case of compact foods or piece goods like fruit, vegetables, or meat products.

It becomes more difficult if one wants to determine the weight of liquid or powdery foods, such as for example flour. In this case, as a rule, a food carrier, such as a bowl is required, into which the food to be weighed is placed. If one now places the bowl, including the flour located therein, onto the kitchen scale, it is not directly possible, by means of the weight display, to determine the weight of the flour, as the scale shows the weight of the bowl together with the weight of the flour. Therefore, the bowl must first be placed on the kitchen scale alone before weighing the flour. After the kitchen scale has settled on a value for the weight, and displays this to the user through the display device, the user can actuate a tare button, in order to set the weight display to zero again. Now the flour can be placed into the bowl, and the weight or the tare weight of the same can be displayed to the user through the display device. This has the disadvantage, however, that it takes a relatively long time until the tare weight of the flour or of the food is displayed to the user. Furthermore, the user must work with the bowl while this is standing on the kitchen scale. It is, however, possible to initially weigh the bowl on the kitchen scale, and to subsequently subtract the determined weight of the bowl from a total weight of the bowl including the flour. This, however, is unsatisfactory for a user, and beyond that, entails the risk that the user miscalculates in the subtraction.

Along with simple kitchen scales, multifunction kitchen appliances with an integrated scale or weighing device are known in the prior art. These types of kitchen appliances have the same problems with regard to the weighing device, however, as are described above with respect to the kitchen scale.

It is the object of the present invention to at least partially resolve the above-described disadvantages. It is in particular the object of the present invention to provide an improved and simplified possibility for weighing foods.

The above object is achieved by the claims. In particular, the above object is achieved by the system according to claim 1, the food carrier according to claim 13, as well as the method according to claim 14. Further features and details of the invention result from the description and the drawings. Here, features, which are described in conjunction with the system, apply, of course also in conjunction with the food carrier according to the invention, as well as the method according to the invention, and vice versa, so that, with respect to the disclosure, reference is or can mutually be made to the individual aspects of the invention.

According to a first aspect of the present invention, a system for the preparing of foods is provided, comprising a housing for receiving the food, a recognition device for recognizing at least one of the food carriers couplable with the system, and thereby recognizing the weight of the food carrier, as well as a determining device for determining the tare weight of the food, based on the detected weight of the food carrier.

A separate weighing of the food carrier on the one hand, and a combination of the food carrier including the food after the actuation of the tare button on the other hand, can thereby be dispensed with. Based on the knowledge about the weight of the food carrier, the tare weight can be quickly and reliably determined.

Furthermore, it is thereby possible to determine the tare weight of the food automatically or in an automated manner, i.e. the determining device is preferably configured to automatically determine the tare weight of the food. The determining device is thereby in particular formed and configured in such a way, that the determining of the weight of the foods, in a coupling of the food carrier, on or in which the foods are supported, with the system, can automatically be carried out. The tare weight of the food can thereby be determined in a particularly reliable manner. A possible calculation work of the user is, in this case, automatically assumed by the determining unit. Calculation errors, which can arise for example through a mental arithmetic by the user, are thereby avoidable.

Beyond that, it is not required, in the present system, that the food carrier is located on or in the system, or on or inside the housing of the system in order to determine the tare weight after a loading of the food carrier with foods. Based on the knowledge about the weight of the food carrier, the tare weight of the food can also then be determined, if the foods are already located on the food carrier, before the food carrier is coupled with the housing. For a user, it is thus, for example, possible to place the food on the food carrier, while this is located on a work surface in the kitchen, and to only subsequently place the food carrier with the food located thereon into the system, in order to have determined the tare weight of the food. The present system is thereby particularly user-friendly.

Herein, a food carrier refers to an open vessel or a closed housing or a sealable vessel can presently be understood. An open vessel can, for example, be a bowl or a plate. A closed housing or sealable vessel can, for example, be a pot with a lid.

Herein and in the context of the present invention, the tare weight of the food refers the net weight of the food, i.e. excluding, for example, the weight of the food carrier. Herein, food is to be understood in plural as well as in the singular form, as, for example, a single apple contains multiple foods.

The couplable food carrier is preferably form-fittingly couplable with the system. I.e. the system is preferably configured in such a way that it is form-fittingly couplable with a suitable food carrier. Through a form-fitting coupling with preferably two of more coupling surfaces of the system, it is possible that the food carrier is, in a coupling with the system, always arranged in a defined relative position to the housing. The food carrier can thereby be recognized particularly simply and reliably by the recognition device.

The coupling between the system and the food carrier means a non-destructive in particular, mechanical coupling. The coupling between the system and the food carrier can, for example, be producible through a latching or clipping device of the system. However, a coupling can also be understood as an electrical or electromagnetic coupling in which no mechanical contact between the system and the food carrier is present. It is hereby conceivable that the food carrier, and thus the weight of the food carrier can be detected through the recognition device, without a mechanical coupling being present between the system and the food carrier, i.e. without the recognition device carrying out a classic weighing process.

The recognition device can be arranged on the housing, outside of the housing, and/or inside of the housing. Accordingly, it is also possible that the recognition device comprises multiple recognition units, which are arranged outside of the housing, as well as also within the housing. Through the recognition unit arranged at least outside of the housing, it is possible to already recognize the food carrier, if the user moves the food carrier in the direction of the system. The weight of the food carrier can also thereby be detected at an early stage, and consequently, the tare weight can be determined quickly in a subsequent determination process.

The present system can, for example, be a kitchen appliance. The housing comprises an interior space, which, through a housing wall relative to an outer space, i.e. a region outside of the housing wall, can be opened, and is closeable or lockable. I.e. the housing can be preferably completely closed or substantially completely closed, so that the interior space, relative to the outside space, is completely or substantially completely lockable or closeable. The fact that the foods can be received inside the housing means that the food can be received or arranged in the interior space of the housing

To determine the tare weight, the recognition device and the determining device stand in communication with one another, in particular in electrical communication connection. Thus, the recognition device can transmit obtained data with respect to the recognized food carrier, as well as the weight of the food carrier, to the determining device, which, based on these data, can determine the tare weight of the food.

According to a further development of the present invention, it is possible that the system comprises a weighing device for weighing the food carrier together with foods stored thereon or therein, and is configured to determine the weight of the food, based on a subtraction of the detected weight of the food carrier from at least the weighed weight of the food carrier and the foods stored thereon or therein. By means of the weighing device, it is possible to particularly simply determine the weight of the food carrier with the foods located thereon or therein. The subtraction which can be carried out through the determining device, furthermore leads to a particularly quick and reliable result with respect to the tare weight of the foods. To determine the tare weight of the foods, the recognition device, the weighing device, and the determining device are in communication with each another, in particular in electronic communications connection. Thus, not only the recognition device can transmit obtained data with respect to the recognized food carrier and the weight of the food carrier, but also the weighing device can transmit the weighed weight or total weight of the food carrier, as well as the foods stored thereon or therein, to the determining device, which, based on these data, can determine or calculate the tare weight of the food.

Moreover, it is conceivable according to the invention that the weighing device comprises at least one strain gauge, which in particular is arranged in at least one stand of the housing. Strain gauges constitute an affordable and space-saving solution for the weighing of the food carrier, as well as the food located thereon or therein. Under the at least one gauge strain, a measuring unit for the detecting of stretching and upsetting deformations is to be understood in the broadest sense. The provided, at least one gauge strain changes its elastic resistance upon a deformation of the same, and can thereby transmit a corresponding signal to the determining device. Due to the fact that the at least one gauge strain is arranged in a stand, or in a lower region or floor region of the system or of the housing, the weight of objects on the housing or above the housing, as well as also the weight of objects inside the housing can be measured in a simple manner.

Furthermore, it is possible according to the present invention that the system is configured as a cooking device for cooking of the food, in particular as an oven. A cooking device means a device, by means of which foods can be supplied with energy, in particular in the form of heat, in such a manner that the foods can be transformed into a state edible for people, or can be improved with respect to a food quality. The food quality is for example characterized by the digestibility and/or usability in the human body. In the broadest sense, an oven is a device for the controlled generation of heat, wherein the heat can herein be used for the preparation of the foods. Therefore, the term oven can also concern a microwave or a toaster. The oven preferably comprises a temperature unit, which enables a zonal heating of the interior space of the housing. To that end, the tempering unit can comprise, for example, heating antennae, which can cause energy or heat input targeted at certain regions in the interior space of the housing. Through the oven according to the invention or the cooking device, a user can dispense with the use of an additional weighing device, for example in the form of a kitchen scale. Costs and storage space can thereby be saved.

Beyond that, it is conceivable, according to the present invention that the recognition device comprises a code scanner for recognizing a code, in particular a QR code and/or a barcode on the food carrier, and thereby for recognizing a food carrier. The code scanner is preferably arranged inside of the housing. Through the code scanner, a suitable food carrier can be recognized in a quick and simple manner. The code scanner can, for example be integrated into a housing wall, or in the housing itself. This allows a particularly space-saving system to be achieved. Within the scope of the present invention, it is also conceivable that the code scanner is arranged outside of the housing, or a least, in the direction outside of the housing, on or in the same. The food carrier can hereby already be recognized, if it moves in the direction of the system, i.e. if the food carrier is not yet in mechanical contact with the system, for example with the housing. It is of course also conceivable in the scope of the present invention that the system comprises multiple code scanners, for example a code scanner as described above outside the housing and a code scanner as described above inside the housing.

It is further possible according to the invention that the recognition device comprises a camera for recognizing the shape of the food carrier, and thereby for recognizing the food carrier, wherein the camera is arranged in particular inside the housing. Through the camera, basically every desired food carrier can be recognized. To that end, the system can, for example, comprise a pixel assessment unit, which assesses pictures captured with the camera and, based on a pixel analysis, recognizes the food carrier captured with the camera. The camera can, for example, be integrated into a housing wall or in the housing itself. A particularly space-saving system can thereby be created. Within the scope of the present invention, it is also conceivable that the camera is arranged outside of the housing, or at least, in the direction outside of the housing, on or in the same. The food carrier can hereby already be recognized, if it moves itself in the direction of the system, i.e. if the food carrier is not yet in mechanical contact with the system, for example the housing. It is of course conceivable within the scope of the present invention that the system comprises multiple cameras, for example, as described above, a camera outside of the housing, and as described above, a camera inside the housing.

According to a further development of the present invention, it is possible that the recognition device comprises an NFC module for recognizing the food carrier. Based one the NFC module, a suitable food carrier, which preferably comprises a NFC counter-module, can be quickly, simply and correctly recognized. Under an NFC module, preferably a module based on RFID technology is to be understood, which is suited for the contact-less transmission of data. The NFIC module can, to that end, for example, also comprise a WLAN module and/or a Bluetooth module. The at least one NFC module can be arranged inside, as well as also outside of the housing.

Furthermore, it is possible according to the present invention that the recognition device comprises a magnetic switching module for recognizing the food carrier, in particular for recognizing a magnetic counter-switching module of the food carrier, and thereby for recognizing the food carrier. Based on the magnetic switching module, a suitable food carrier, which preferably comprises an associated magnetic counter-switching module, can be recognized quickly, simply, and correctly. A magnetic switching module is preferably understood to be a magnetic switch which, upon actuation of the same, forwards a signal to the determining device, in order to transmit data to this with respect to the food carrier and its weight. The at least one magnetic switching module can be arranged inside the housing, as well as also outside of the housing.

According to the present invention, it is of further advantage if the system comprises a coupling device, for coupling with the food carrier, in a defined position in the system, wherein the coupling device is in particular arranged on the housing, and here is arranged inside or outside of the same. Through the coupling device, it can be achieved that the food carrier, is always positionable in a defined position in the system or on the housing. It is thereby, for example, particularly reliably possible to recognize the food carrier, and correspondingly, the weight of the food carrier, through the code scanner, the camera, as well as in particular through the NFC module and the magnetic switching module. Due to the fact that the food carrier, through the coupling device, can always be received in the same position in the system, a particularly reliable interaction between, for example, the NFC module and the NFC counter-module, and/or between the magnetic switching module and the magnetic counter-switching module can be reached. The coupling device is preferably configured as a mechanical coupling device, for producing a mechanical coupling between the coupling device and the food carrier. The coupling device can, to that end, comprise, for example, a latching and/or clipping element for a preferably form-fitting coupling with an associated food carrier, which contains a corresponding latching and/or clipping element.

Within the scope of the present invention, the system can furthermore comprise a storage device, in which weight data related to different food carriers is stored. Through direct access to the weight data in a system-side storage device, the determining device can obtain the tare weight of the food and place it correspondingly quickly at the disposal of the user. The storage device itself preferably comprises a magnetic or non-volatile electronic storage medium. The storage device can be made available inside of the housing, as well as also outside of the housing.

According to the invention, it can also be of advantage if the system comprises a communications device for obtaining recognition data, via the internet or a different wired or wireless network for recognizing the food carrier. Food carriers which, for example, were not yet known at the point in time of the manufacture of the present system can thereby also be recognized. By means of the communications device, the system always has access to all information which is required for the correct recognition of all suitable food carriers. A communications connection exists between the communications device and the recognition device for transmitting the recognition data. The communications device can be made available inside of the housing, as well as also outside of the housing.

Furthermore, it is possible, according to the present invention that the system comprises a display device for displaying the determined weight of the food. Through the display device, the tare weight of the food can be directly displayed to the user, without them having to actuate a tare button in the in meantime. The display device is arranged in the system preferably outside the housing so that it is easy for the user to read. The display device preferably comprises a display unit. The display device can in this case, be integrated in to a multifunction display unit, through which operating parameters for the system, for preparing the food, can also be entered by the user. The display unit is preferably configured as a touch display.

According to a further aspect of the present invention, a food carrier is made available for use in a system as described above. The food carrier comprises a code readable by the code scanner, an NFC counter-module for communication with the NFC module and/or a magnetic counter-switching module for interaction with the magnetic switching module. The food carrier according to the invention comes with the same advantages as have been described in detail with respect to the system according to the invention.

According to a further aspect of the present invention, a method for automatically determining the weight of foods is made available. The method comprises the following steps:
providing a system for preparing foods, with a housing for receiving the food,
recognizing at least one food carrier couplable with the system, on or in the housing,
assigning a weight to the recognized food carrier, and
determining the tare weight of the food based on the detected weight of the food carrier.

The method according to the invention thus comes with the same advantages as have been described in detail with respect to the system according to the invention.

Moreover, it is possible according to the present invention that operating parameters of the system can be set for preparing the food, depending on the determined tare weight of the food. I.e. depending on the determined tare weight of the food, a temperature in the housing, or the type of the temperature in the housing can, for example, be set. If the system is configured as an oven, an recirculating heat operation or an operation with top/bottom heat can thus be set at a defined temperature, for example dependent upon the determined weight of the food. The method, according to the invention, for determining the weight of foods can hereby be carried out with a system as described above, an in particular with a food carrier as described above, wherein the described device features are modifiable in corresponding method steps or can be carried out as corresponding method steps.

Further measures improving the invention result from the following description for different exemplary embodiments of the invention, which are schematically represented in the figures. All features and/or advantages resulting from the claims, the description or the drawings, including construction details and spatial arrangements, can be essential for the invention by themselves, as well as in the different combinations.

In each case schematically shown are in:

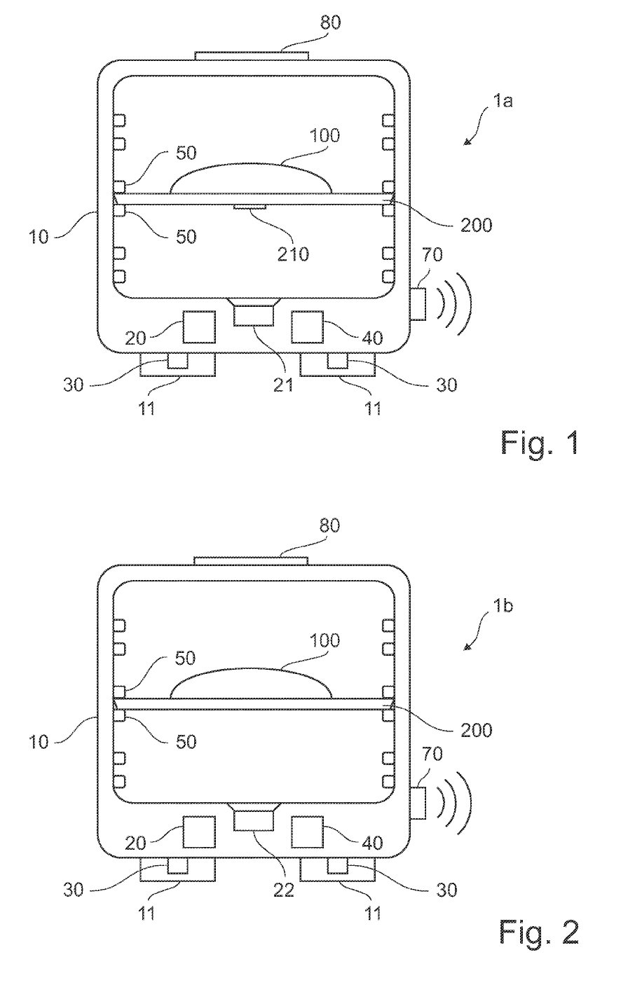

FIG. 1 a system according to a first embodiment of the present invention,

FIG. 2 a system according to a second embodiment of the present invention,

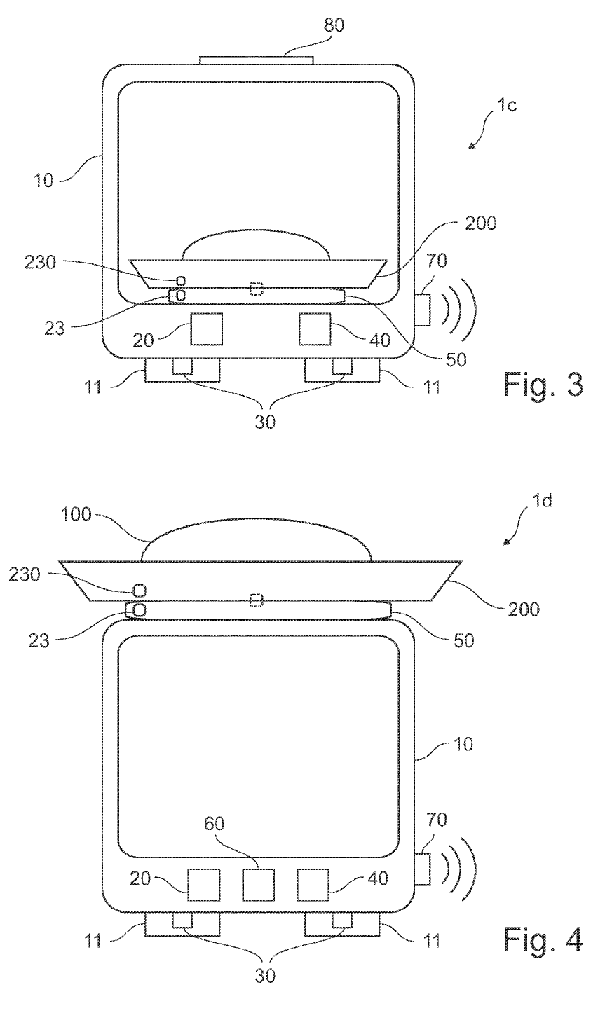

FIG. 3 a system according to a third embodiment of the present invention,

FIG. 4 a system according to a fourth embodiment of the present invention, and

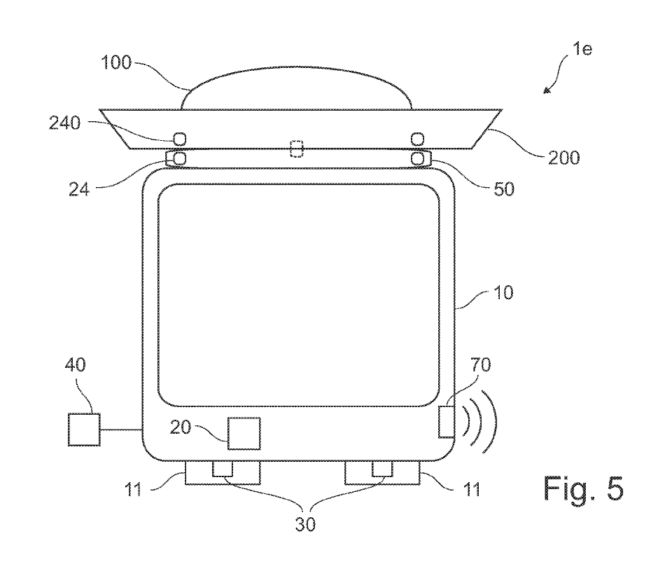

FIG. 5, a system according to a fifth embodiment of the present invention.

Elements with the same function and effect are respectively provided, in the FIGS. 1 to 5, with the same reference characters.

FIG. 1 shows a system 1a, configured as an oven, for the preparation of foods 100 according a first embodiment. The system 1a comprises a housing 10 for accommodating the food 100, presently bread dough. The system 1a moreover comprises a recognition device 20 for recognizing at least one food carrier 200 couplable with the system 1a. The food carrier 200, configured as a baking tray, is mounted in a rail-like coupling device 50, which is formed in the interior space of the housing 10, in a defined position in system 1a.

The recognition device 10 further comprises a code scanner 21 for recognizing a code 210. The code scanner 21 is, in the illustrated embodiment, arranged in the housing 10 or integrated in this. The code 210 is, according to FIG. 1, arranged on the lower side of the food carrier 200. It is to be noted here, that the code 210 is illustrated as a projection from the food carrier 200 merely for the purpose of better understanding. In practice, the code 210 is rather flush, or substantially placed flush with the lower side of the food carrier 210, for example as an adhesive label or as an imprint. Based on the code 210, which in the present case is a QR code, the food carrier 200 can automatically be recognized. Accordingly, the weight of the food carrier 200 can thereby automatically be detected or assigned. To that end, the system 1a comprises a communications device 70 for obtaining recognition data via the internet or a different network. Through the communications device 70, the system 1a can obtain all available weight data for various food carriers 200, for example via the internet. The communications device 70 is, according to FIG. 1a, arranged, at least in sections, outside of the housing 10 for a better reception or for a better transmission power.

The system 1a illustrated in FIG. 1 further shows a determining device 40 to determine the tare weight of the food 100 based on the detected weight of the food carrier 200. The determining device 40, to that end, comprises a computing unit. As shown in FIG. 1, the determining device 40 is configured integrated into the housing 10. The system 1a shown in FIG. 1 moreover comprises a weighing device 30 for weighing the food carrier 200 together with the foods 100 stored thereon. The determining device 40 is here configured to determine the weight of the food 100, based on a subtraction of the detected weight of the food carrier 200 from the weighed weight of the food carrier 200 and the food 100 stored thereon or therein.

The weighing device 30 comprises two strain gauges which are arranged in the two stands 11 or stand portions of the housing 10. More or fewer strain gauges can also of course be provided in the system. The system 1a according to the first embodiment further comprises a display device 80 for displaying the determined weight of the food 100.

FIG. 2 shows a system 1b according to a second embodiment. The second embodiment differs in particular from the first embodiment in that the system 1b or the recognizing device 40 comprises a camera 22 in place of the code scanner 210. The camera is configured to recognize the shape of the food carrier 200, and thereby to recognize the food carrier 200. The camera 22, just like the code scanner 21, is configured integrated into the housing 10.

FIG. 3 shows a system 1c according to a third embodiment. The third embodiment differs in particular from the other embodiments in that the system 1b or the recognition device 20, respectively, comprises a NFC module 23. The NFC module 23 is configured to recognize an NFC counter-module 230, which is located in the food carrier 200, and thereby to recognize the food carrier 200. The NFC module 23 is, according to FIG. 3, configured in the coupling device 50 inside the housing 10, i.e. within the interior space of the housing 10.

FIG. 4 shows a system 1d according to a fourth embodiment. The fourth embodiment in particular differs from the third embodiment in that the NFC module 23 is configured in a coupling device 50 outside of the housing 10, and correspondingly, outside of the interior space of the housing 10. Furthermore, the system 1d illustrated in FIG. 4 comprises a storage device 60, in which weight data, associated with different food carriers 200, are stored.

FIG. 5 shows a system 1e according to a fifth embodiment. The fifth embodiment in particular differs from the other embodiments in that the system 1e or the recognition device 20 comprises a magnetic switching module 24. The magnetic switching module 24 is configured to recognize a magnetic counter-switching module 240 in the food carrier 200, and thereby to recognize the food carrier 200. The magnetic switching module 24 comprises two magnetic switches. The magnetic counter-switch module 240 comprises two counter magnetic switches, which correspond, or can be brought into operative connection with the two magnetic switches. The magnetic switching module 24 is designed according to FIG. 5 in the coupling device 50 outside the housing 10 and correspondingly outside the interior of the housing 10. FIG. 5 furthermore differs from the other embodiments in that the determining device 40 is formed outside of the housing 10, and correspondingly outside of the interior space of the housing 10, and the communications device 70 is configured as to be integrated flush with the housing 10. Such a modification is of course also conceivable in all other possible embodiments illustrated. The same also applies to the recognizing device 20, which can be formed outside of the housing 10, as well as also inside of the housing 10.

Subsequently, with respect to FIG. 1, a method according to an embodiment is described. In the method, the system 1a disclosed above in detail is initially made available. Subsequently, the food carrier 200 is inserted into the coupling device 50, in the interior space of the housing 10. Now, the code 210 on the underside of the food carrier 200 is recognized by the recognizing device 20, i.e. the code scanner 21. The system 1a thereby knows which food carrier 200 is located in the housing 10, and can assign this food carrier 200 the matching weight. Simultaneously, by means of the weighing device 30, the food carrier 200, along with the foods stored thereon is weighed, and thereby a corresponding total weight is measured. Now, the detected weight of the food carrier 200 is subtracted from the weighed total weight, i.e. the weight of the food carrier 200 and the food 100 stored thereon. The result of the subtraction is the tare weight of the food 100. This result is now displayed on the display device 80.

Subsequently, operating parameters of the system 1a can be set to prepare the food 100, such as for example an oven temperature, depending upon the determined tare weight of the food 100.

FIGS. 1 to 5 illustrate the recognizing device 20 and the determining device 40 as separate units. The recognizing device 20 and the determining device 40 can, however, also be configured as a unit integrated with one another outside of the housing 10, as well as also inside of the housing 10. Furthermore, it should yet be pointed out to the fact that the code scanner 21, the camera 22, the NFC module 23, and/or the magnetic switching module 24 can be configured as an integral part of the recognizing device 20, although the corresponding units in the FIGS. 1 to 5 are illustrated as spatially separated from one another.

### LIST OF REFERENCE CHARACTERS

1 system
10 housing
11 stand
20 recognition device
21 code scanner
22 camera
23 NFC module
24 magnetic switching module
30 weighing device
40 determining device
50 coupling device
60 storage device
70 communications device
80 display device
100 food
200 food storage vessel
210 code
230 NFC counter-module
240 magnetic counter-switching module

1-16. (canceled)

17. A system for preparing foods, comprising a housing for receiving the food, a recognition device for recognizing at least one food carrier couplable with the system, and thereby recognizing the weight of the food carrier, as well as a determining device for determining the tare weight of the food based on the detected weight of the food carrier.

18. The system according to claim 17,
wherein
the system comprises a weighing device for weighing the food carrier together with foods stored thereon or therein, and the determining device is configured for determining the weight of the food, based on a subtraction of the detected weight of the food carrier from at least the weighed weight of the food carrier and the food stored thereon or therein.

19. The system according to claim 18,
wherein
the weighing device comprises at least one strain gauge.

20. The system according to claim 17,
wherein
the system is configured as a cooking device for cooking the food.

21. The system according to claim 17,
wherein
the recognition device comprises a code scanner for recognizing a code on the food carrier (200), and thereby for recognizing the food carrier, wherein the code scanner.

22. The system according to claim 17,
wherein
the recognition device comprises a camera for recognizing the shape of the food carrier, and thereby to recognize the food carrier.

23. The system according to claim 17,
wherein
the recognition device comprises an NFC module for recognizing the food carrier.

24. The system according to claim 17,
wherein
the recognition device comprises a magnetic switching module for recognizing the food carrier.

25. The system according to claim 17,
wherein
the system comprises a coupling device for coupling with the food carrier in a defined position in the system.

26. The system according to claim 17,
wherein
the system comprises a storage device, in which weight data assigned to different food carriers is stored.

27. The system according to claim 17,
wherein
the system comprises a communications device for obtaining recognition data, via the internet or a different wired or wireless network for recognizing the food carrier.

28. The system according to claim 17,
wherein
the system comprises a display device for displaying the determined weight of the food.

29. A food carrier for use in a system for preparing foods, comprising a housing for receiving the food, a recognition device for recognizing at least one food carrier couplable with the system, and thereby recognizing the weight of the food carrier, as well as a determining device for determining the tare weight of the food based on the detected weight of the food carrier, comprising a code readable by the code scanner, an NFC counter-module for communication with at least the NFC module or a magnetic counter-switching module for interaction with the magnetic switching module.

30. A method for automatically determining the weight of food in a system for preparing food, with a housing for receiving the food, comprising the steps:
recognizing at least one food carrier, couplable with the system, on or in the housing;
assigning a weight to the recognized food carrier; and
determining the tare weight of the food based on the detected weight of the food carrier.

31. The method according to claim 30,
wherein
operating parameters of the system for preparing the food are set depending on the determined tare weight of the food.

32. The method according to claim 30 for determining the weight of food, with a food carrier for use in a system for preparing foods, comprising a housing for receiving the food, a recognition device for recognizing at least one food carrier couplable with the system, and thereby recognizing the weight of the food carrier, as well as a determining device for determining the tare weight of the food based on the detected weight of the food carrier, comprising a code readable by the code scanner, an NFC counter-module for communication with at least the NFC module or a magnetic counter-switching module for interaction with the magnetic switching module.
